(19) United States
(12) Patent Application Publication
(10) Pub. No.: US 2020/0261304 A1
(43) Pub. Date: Aug. 20, 2020

(54) THERMAL MASSAGE DEVICE

(71) Applicant: Rizik & Friends, LLC, Grand Rapids, MI (US)

(72) Inventors: John Rizik, Grand Rapids, MI (US); Brendan Mangan, Seattle, WA (US)

(21) Appl. No.: 16/793,754

(22) Filed: Feb. 18, 2020

Related U.S. Application Data
(60) Provisional application No. 62/807,855, filed on Feb. 20, 2019.

(51) Int. Cl. A61H 15/02; A61H 15/00

(52) U.S. Cl. CPC A61H 15/02; A61H 15/0092; A61H 2201/0207; A61H 2205/081; A61H 2201/1253; A61H 2201/0242; A61H 2201/1635; A61H 2201/0285

(57) ABSTRACT

A thermal massage device for therapeutic pressure or heat transfer to a portion of a user's body. The device includes a cane-shaped body with a heat conductive contact surface at the distal end of the hooked portion of the cane shape. Handles are coupled to a straight portion of the cane-shaped body. The device selectively provides therapeutic relief through pressure and temperature control, or a combination thereof. The pressure is dependent upon the user's manipulation of the hooked end. The temperature is selectively controlled via a thermal control system, such as a Peltier Effect device. The device may include airflow passages, vents, and fans for providing airflow through the body to facilitate temperature regulation of the device.

### FIELD OF THE INVENTION

The present invention relates to a personal massage device for an individual to administer a massage to their body.

### BACKGROUND OF THE INVENTION

Devices have been used for massage and back pain relief, including implements that have various shapes and sizes of contact surfaces for applying pressure and massaging of parts of the body. Massage devices are used to provide relief from cramping or other pain. Massage devices are used for manipulation by the user on themselves, such as for pressure or massage of the legs, feet or other regions accessible to the user. Various such devices use one or more rollers that are mounted on an axle with spaced handles on the ends of the axle to be grasped while for rolling along the region to be treated.

Thermal treatment for back pain, including heating pads, such as electric heating pads and pads treated or containing a heat generating substance, have been used for such treatment. Cold packs are also commonly used for treatment of back pain. Such cold packs include bags or containers that may be filled with ice, or pads or containers holding a substance that may be frozen or otherwise cooled and then applied to the back of the person for treatment. Such cold packs have also employed a variety of shapes. A difficulty with traditional heating pads or ice pads is that such methods often take extended time to prepare the treatment pad by freezing or boiling. Electric heating pads may be quicker to deploy, but such pads are difficult to self-administer. Heating and cooling are important in the treatment of muscular hypertrophy and somatic dysfunction. Heat provides relief to chronic back pain and muscle soreness. Cooling in the acute phase of back pain can provide immediate relief and prevent worsening of the condition.

### SUMMARY OF THE INVENTION

The present invention provides a thermal massage device for treatment or relief of back pain or discomfort. The massage device includes an elongated body shape that is configured to be held by the user and allows the user to access their own back to facilitate massaging of the afflicted area. The thermal massage device includes a heat generating system that produces heat or cooling at the contact surface of the device so as to employ thermal treatment as well as physical massage. The shape and weight of the massage device provide a portable option for therapeutic massage. The massage device utilizes a thermally insulating material to limit the heating and cooling effect to substantially only the contact surface of the device. The cane-shape of the massage device enables patients to use leverage to direct force to a specific target area without distorting the natural musculature of the back to reach otherwise difficult-to-reach areas and allows the patient to control the amount of pressure they apply to their body.

In one form of the present invention, a massage device is provided for providing pressure and thermal treatment to a region of a user's body that is otherwise difficult to reach. The massage device includes an elongated cane-shaped body having a hooked end. The hooked end defines an application end of the massage device having a heat-conductive contact surface proximate the distal end of the hooked end. The contact surface contacts the user's body to transfer heat, pressure, or both simultaneously to the user's body. The device includes a thermal regulation system to provide selective temperature adjustability at the contact surface. The massage device includes at least one grip region thereon for a user to grip and control the device. Preferably, the contact surface is generally spherical. Optionally, the massage device includes a handle disposed on a portion of the elongated cane-shaped body that is spaced apart from the hooked end.

In one aspect, the thermal regulation system of the massage device includes a Peltier effect driven system, such as a Peltier device, that selectively provides heating or cooling to the contact surface to allow a user to apply heat or cooling to their body. In one aspect, the cane-shaped body includes a passage within the body that enables air to flow along the passage to assist in regulation of temperature at the application end of the device. The massage device may include a fan disposed in fluid communication with the passage to draw air through the passage. Additionally, a vent passage may be disposed in the body adjacent to the passage to vent or exhaust air from the thermal regulation system. A handle disposed on the body of the device may optionally include a handle vent in fluid communication with the vent passage to vent fluid from the thermal regulation system at least partially through the handle.

In another aspect, the elongated body of the massage device includes a J-shaped configuration having a substantially straight longer leg and a hooked shorter leg. At least one gripping region is disposed on the longer leg. A contact end region is disposed at a distal end of the shorter leg, and a selectively operable thermal control system for thermal adjustment to the contact end region. The hooked shorter leg is generally curved between the contact end region and the longer leg.

Thus, the present invention provides an elongated thermal massage device that provides a user to direct pressure and/or thermal treatment at hard to reach parts of their body. The device includes a contact surface at one end of a hooked portion of the elongated body, wherein the hooked portion is configured to access a hard to reach location on the body, such as the back. A grip portion is provided to allow a user to grip, control, and manipulate the massage device from the front of their body with limited or no difficult reaching. The grip portion may include handles to provide additional gripping locations. A thermal regulation system is provided to adjust a temperature of the contact surface, such as by heating or cooling the contact surface, to allow a user to apply heat or cooling treatment to their body. A fan and airflow passages and vents may be provided to facilitate temperature regulations of the contact surface of the massage device.

Changes and modifications in the specifically described embodiments can be carried out without departing from the principles of the present invention which is intended to be limited only by the scope of the appended claims, as interpreted according to the principles of patent law including the doctrine of equivalents.

### BRIEF DESCRIPTION OF THE DRAWINGS

FIG. 1 is a general oblique view in perspective of a thermal massage device in accordance with the present invention;

FIG. 2 is a cross-sectional view of the thermal massage device of FIG. 1, illustrating a vent and an airflow chamber of the thermal massage device in accordance with the present invention;

FIG. 3 is an enlarged perspective view of a contact end of the thermal massage device of FIG. 1;

FIG. 4 is an enlarged perspective view of a handle portion of the thermal massage device of FIG. 1;

FIG. 5 is a perspective view of the thermal massage device of FIG. 1, depicting use of the device by an individual in the posterior view;

FIG. 6 is a perspective view of the thermal massage device of FIG. 1 depicting use of the device by an individual in the lateral view.

### DESCRIPTION OF THE PREFERRED EMBODIMENTS

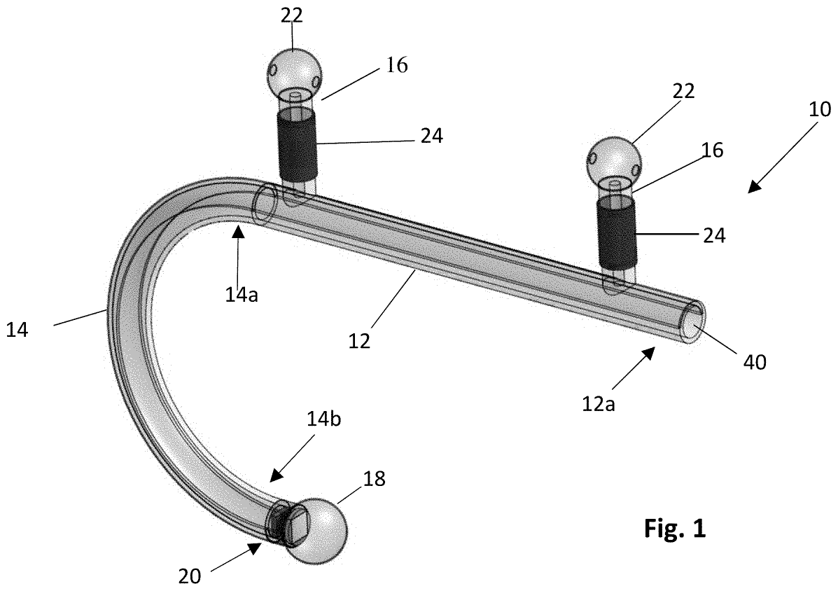

Referring now to the drawing with greater particularity, a preferred embodiment of the invention is shown in FIG. 1 and comprises a massage device 10 having an elongated body 12 and a curved return-end region 14. A pair of handles 16 extend laterally from elongated body 12 to provide handholds or grips for the person using device 10. At the terminal end of curved return-end region 14 a contact or application end 18 provides a heat-conductive contact surface to be pressed against the part of the user's body to be treated, such as the user's back or posterior. A thermal control system 20 provides thermal control of the heat-conductive contact surface of contact end 18 in order to provide thermal treatment at the region to be treated.

In the illustrated embodiment of FIGS. 1 and 5-6, the massage device 10 has an elongated body defined by “J” or “cane” shape. The cane shape includes a curved return-end region 14 that may be formed as a bent or extruded hollow element. The cane shape includes a substantially straight leg or elongated body 12 that extends from a first end 14a of the curved return-end region 14 in order to provide a gripping region of device 10 and the other, terminal end 14b of the curved return-end region 14 is positioned such that the contact end 18 may be pressed against the back of the user when the user is gripping the device 10 at the straight leg. Alternatively the return-end region 14 of device 10 may be rectangular shaped or otherwise configured to provide the ability to position contact end 18 against the user's back while the user holds part of device 10 in front of the user. Elongated body 12 and return-end region 14 are preferably a bar with cylindrical cross section, but alternatively may have other cross-sections and configurations, such as rectangular, oval, faceted or other configurations.

The handles 16 are preferably hand-sized rods that protrude to the side of elongated body 12 and each includes an enlarged knob 22 at the distal end of the handle 16. Knobs 22 assist in preventing a user's hands from slipping off the end of the handles 16 during use of device 10 as well as provide for venting of device 10 as described herein. Handles 16 may be cylindrically-shaped, linear rods, but alternatively may have other cross-sections and configurations. Alternative embodiments include handles that provide oval, rectangular, faceted and other cross sections, an oval or curved protrusion or other shaped protrusion, and may comprise a curved or pistol grip configuration. Knobs 22 may be configured in other shapes and may provide a planar disc or other stop surface at the end of handle 16. A sleeve or grip surface 24 on each handle 16 may provide a cushion or grip for the user and provide thermal insulation for handle 16.

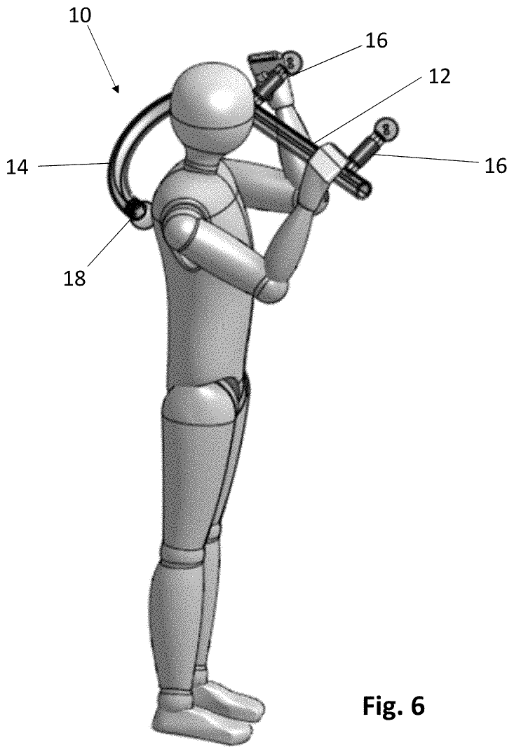

In the illustrated embodiment, device 10 includes a pair of spaced handles 16 which allow the user to grasp each of the handles with a hand. In the preferred form of FIG. 1, handles 16 protrude to the same side and at the same angle from the elongated body 12. Handles 16 may alternatively be oriented at different angles from the elongated body 12 and may protrude from different points about the circumference of elongated body 12. Alternatively device 10 may include one handle 16 to be grasped by the user with one hand while holding the elongated body 12 with the other hand, similar to that depicted in FIG. 6. Alternatively a single handle may be configured to be held and controlled with two hands and may include a bend or other shape to assist in control of device 10 while massaging. Still alternatively, device 10 may not include protruding handles so that the user grips the elongated body 12 during use. One or more sleeves or grip surfaces may be provided on elongated body 12 to assist in holding and controlling of device 10 while in use. Yet alternatively more than two handles may be provided and provide alternative hand-holds for the user to select for comfort in use and alternative control points. Such plurality of alternative handles may be oriented and spaced at differing locations along and about device 10.

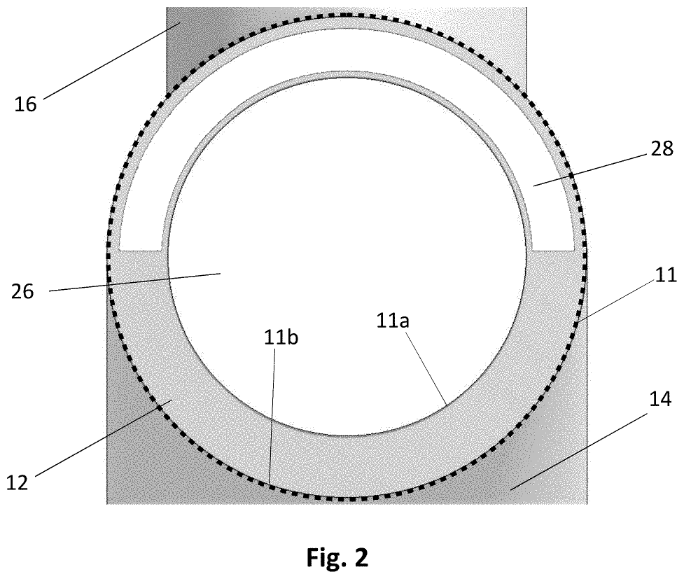

As illustrated in FIG. 2, the massage device 10 is defined by circular cross section as depicted by the dashed line in FIG. 2. The cross section 11 of the massage device 10 defines a hollow cylinder having an inner wall 11a and an outer wall 11b, the hollow interior of the massage device 10 provides an airflow channel 26 along device 10. Between the inner wall 11a and the outer wall 11b of the massage device 10 end 14 is a vent channel 28 that provides venting for the thermal control system 20 along the length of the device 10. Other alternative venting and airflow passages for thermal control system 20 may be provided.

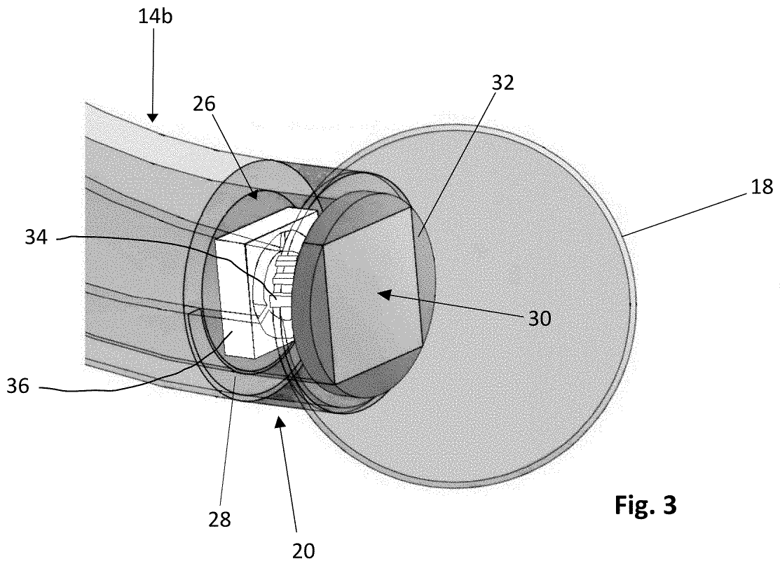

The thermal control system 20 provides thermal control for contact end surface 18. In the illustrated embodiment of FIGS. 1 and 3, the thermal control system 20 includes a thermal electric device 30, such as a Peltier device, that is selectively operable to function as a heating element, cooling element, or both, such as employing the Peltier Effect. The thermal control system 20 is located between the terminal end 14b of the return-end region and the contact end surface 18 (FIG. 3). The thermal electric device 30 includes conductor plates of different material that are positioned so that a current running through a junction between the plates creates a heat flux between the plates. The thermal electric device 30 is selectively operable to either heat or cool the contact end surface, wherein direction of the current through the device 30 defines whether the device 30 is heating or cooling. The configuration of the contact end surface 18 and the thermal electric device, along with the Peltier effect, enables the temperature of the massage device to rapidly change from hot to cold or vice versa in a matter of minutes to facilitate a variety of therapeutic treatments.

An insulated seal 32 is positioned between the thermal device 30, the contact end 18, and the return-end region 14 to moderate the flow of heat between the thermal device 30 and the contact end 18. A heat sink 34 and a fan 36 are located on the return-end side of thermal electric device 30 to transfer heat away from the thermal device 30. The fan 36 is located proximate the discharge end of the airflow channel 26. The fan 36 is configured to induce airflow to the thermal electric device 30, such that air is drawn into airflow channel 26, and subsequently exhausts through vent channel 28.

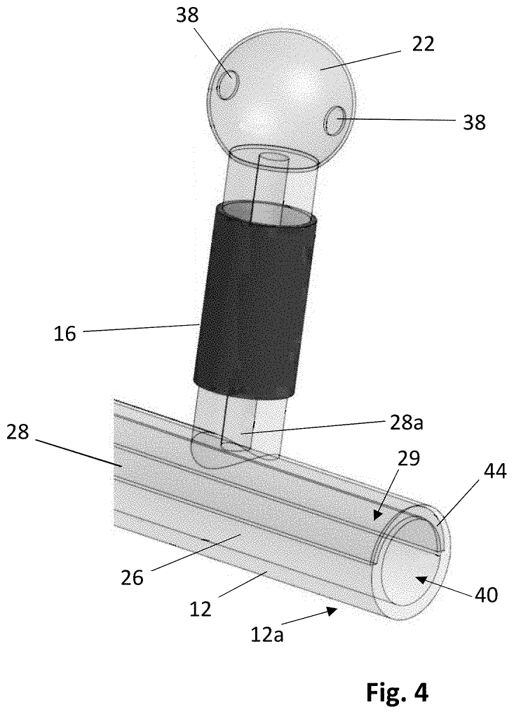

As shown in FIG. 4, open vents 38 are disposed in the enlarged knobs 22 of the handles 16. The vents 38 open into an extension 28a of vent channel 28 that extends along handle 16 and communicates along vent channel 28a from vents 38 to the vent channel 28. The vent channel 28a is in fluid communication with the vent channel at a proximal end of the handle 16 (FIG. 4). Alternatively vents 38 may be located proximate the thermal control system 20 and contact end 18 and configured to vent away from the body of the user when in use. The vent channel 28 is sealed by an end seal 44 at a vent channel distal end 29 located in proximity to a distal end 12a of elongated body 12 (FIG. 4). The end seal 44 forces exhausted air to exhaust through the vents 38 in the handles 16. The flow of exhaust air through the handles 16 and vents 38 may transfer heat to the knobs 22 to heat or cool the knobs 22. The airflow channel 26 is at least partially open to the atmosphere at the distal end 12a of the elongated body 12 to allow ambient air to be drawn into the airflow channel 26. A hole 40 at the distal end 12a of the elongated body 12 defines the at least partial opening of the airflow channel 26. The hot or cold air is exhausted through the vent chamber 28 within device 10, is vented to the surrounding environment via the vents 38 in handle knobs 22.

Thermal control system 20 includes a power supply (not shown) that powers the thermal electric device 30 and the fan 36. The power supply for thermal control system 20 may include an electrical supply cord that runs along elongated body 12 and return-end region 14, such as within airflow channel 26, and out through the hole 40 at the distal end 12a, to a plug for an electrical outlet. Alternatively a battery power supply system may be included. A battery compartment may be incorporated into elongated body 12 and wired to thermal electric device 30 and fan 36. A control switch (not shown) for thermal control system 20 provides on-off and selection control, and provides for selection of heating and cooling treatment options and selective adjustment of the amount or degree of thermal treatment to be applied.

The thermal massage device 10 may be made of any thermally insulating material capable of providing a rigid but flexible support, such as metal, polymers, glass or other thermally conductive material. It is also preferred that the selected material be relatively light to maximize ease of use and portability. While size may be variable, dimensions should approximate 25×15×1 inches with a total weight not exceeding 2 lbs. The knobs 18, 22 on each tip of the massage device 10 and handles 16 are preferably approximate 1.75 inches in diameter. The knob 18 at the terminal end 14b of the hooked portion 14 of the massage device 10 is preferably a thermally conductive material firm enough to apply pressure to the tender points without being hard enough to cause further pain, such as metal or plastic. The remaining knobs 22 may be the same material as the rest of the massage device 10.

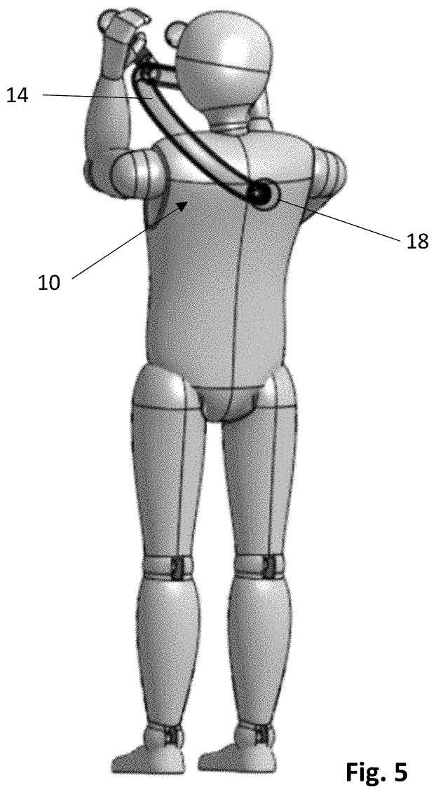

The following is a description of an intended use of the massage device 10. In use, as illustrated in FIGS. 5 and 6, the massage device 10 may be held vertically and hooked over the user's shoulders, in the sitting or standing position, with the knob 18 of at the terminal end 14b of the hooked portion 14 directly on the desired location of the user's back. As the user pulls anteriorly using the handles 16 protruding from the elongated body 12 of device 10, the contact end 18 applies pressure to the desired location on the user's back. The thermal device 30 provides heating or cooling that is combined with pressure to maximize therapeutic relief. The massage device 10 may be configured with multiple temperature settings, and preferably the device includes one of two preconfigured temperature settings (e.g. heat alone, or both heat and cool). The heat setting is preferably preconfigured to approximately one hundred-fifteen (115) degrees Fahrenheit and, if equipped, the cool setting is preferably preconfigured to thirty-two (32) degrees Fahrenheit. Under certain recommended therapeutic instructions, heat may be applied for 5-30 minutes, cool for 5-15 minutes. While a user may apply the contact end 18 directly their skin, it is preferred that the massage device 10 not be applied directly to skin.

It is apparent one may massage any portion of the neck, upper, or lower back with this device as well as numerous other points of discomfort around the body. Included among the benefits provided by embodiments of the invention are the providing of therapeutic relief for neck and upper back pain, providing a mechanism for an individual to perform self-massage, providing an individual a mechanism for controlled heating combined with application to a point of pressure, and providing an individual a mechanism for controlled cooling combined with application to a point of pressure. These and other benefits will be recognized by ones skilled in the art from the disclosure and description provided herein.

While the appearance and embodiment of this invention have been described thereof, it is clear that modifications and changes may be made by those with knowledge of the subject material at hand without departing from the spirit and scope of this invention, as defined by claims appended hereto and the scope of protection the law allows.

The embodiments of the invention in which an exclusive property or privilege is claimed are defined as follows:

1. A massage device for providing pressure and thermal treatment to a region of a user's body, said device comprising:
an elongated cane-shaped body having a hooked end that provides an application end of said device;
a heat-conductive contact surface at said application end, said contact surface configured for contact with the user's body to transfer at least one chosen from pressure and heat to the user's body; and
a thermal regulation system in said device located and adapted to provide temperature adjustment at said contact surface;
said device comprising at least one grip region thereon for a user to grip and control said device.

2. The massage device of claim 1, wherein said thermal regulation system comprises a Peltier effect driven system.

3. The massage device of claim 2, wherein said cane-shaped body includes a passage therein enabling air to flow along said passage to assist in regulation of temperature at said application end of said device.

4. The massage device of claim 3, further comprising a fan disposed in fluid communication with said passage, said fan configured to draw air through said passage.

5. The massage device of claim 1, wherein said contact surface is generally spherical.

6. The massage device of claim 1, wherein said cane-shaped body includes a passage therein that provides an airflow path along said passage to assist in regulation of temperature at said application end of said device.

7. The massage device of claim 6, further comprising a fan disposed proximate said application end to generate air flow in said passage.

8. The massage device of claim 7, further comprising a vent passage disposed in said body adjacent to said passage and configured to vent fluid from said thermal regulation system.

9. The massage device of claim 8, further comprising a handle disposed on a portion of said elongated cane-shaped body that is spaced apart from said hooked end, said handle comprising a handle vent in fluid communication with said vent passage to vent fluid from said thermal regulation system at least partially through said handle.

10. A massage device comprising:
an elongated body having at least one gripping region;
a return end on said body having a contact surface on the distal end thereof; and
a heating element coupled to said device to selectively apply heat to said contact surface;
whereby said massage device is configured to be held by a user by said at least one gripping region at a position forward of the user's body while said contact surface is pressed against the back of the user.

11. The massage device of claim 10, wherein said heating element is a Peltier device.

12. The massage device of claim 10, further comprising a cooling element coupled to said device to selectively apply cooling to said contact surface.

13. The massage device of claim 12, wherein said heating element and said cooling element comprise a single thermal regulation device.

14. The massage device of claim 10, wherein said elongated body comprises a J-shaped body having a plurality of handles spaced along said J-shaped body.

15. A thermal treatment device comprising:
an elongated body comprising a J-shaped configuration having a substantially straight longer leg and a hooked shorter leg;
at least one gripping region disposed on said longer leg;
a contact end region disposed at a distal end of said shorter leg; and
a selectively operable thermal control system for thermal adjustment to said contact end region.

16. The thermal treatment device of claim 15, further comprising a handle disposed on said longer leg of said elongated body.

17. The thermal treatment device of claim 16, further comprising a plurality of handles on said elongated body.

18. The thermal treatment device of claim 15, wherein said thermal control system is configured to employ the Peltier Effect.

19. The thermal treatment device of claim 15, wherein said shorter leg of said elongated body defines a return end region of said device, a distal end of the return end portion is coupled to said contact end region and a proximal end of said return end region is coupled to said longer leg of said elongated body.

20. The thermal treatment device of claim 15, wherein said hooked shorter leg is generally curved between said contact end region and said longer leg.
